(19) United States
(12) Patent Application Publication
(10) Pub. No.: US 2019/0310622 A1
(43) Pub. Date: Oct. 10, 2019

(54) METHOD AND SYSTEM TO IMPLEMENT ZONAL ACCESS RIGHTS

(71) Applicant: Lenovo (Singapore) Pte. Ltd., New Tech Park (SG)

(72) Inventors: Scott Wentao Li, Cary, NC (US); Zhenglong Bai, Cary, NC (US); Matthew Carl Etter, Durham, NC (US); Marco Alberto Gonzalez, Durham, NC (US)

(21) Appl. No.: 15/944,864

(22) Filed: Apr. 4, 2018

(51) Int. Cl. G05D 1/00; G08G 5/00

(52) U.S. Cl. CPC G05D 1/0011; G08G 9/00; G08G 5/0069; G08G 5/006

(57) ABSTRACT

Methods and apparatus are provided for implementing zonal access rights for drones. The methods and apparatus broadcast zonal access rights from a wireless zonal access (WZA) apparatus in connection with a local environment. The zonal access rights indicate device permissions granted in connection with the local environment for an electronically-controlled mobile (ECM) device. Methods and apparatus are provided that receive a broadcast message at an ECM device, obtain zonal access rights from the broadcast message, determine device permissions granted for the ECM device in connection with a local environment based on the zonal access rights and manage operation of the ECM device relative to the local environment based on the zonal access rights.

### BACKGROUND

Embodiments of the present disclosure generally relate to methods and systems for implementing zonal access rights for electronically-controlled mobile (ECM) devices.

Currently, ECM devices, such as drones, are readily available for hobbyists and professionals. Drones, in particular are available in various configurations ranging from toy drones to expensive photography drones. Attached cameras on drones are capable of capturing high definition video and high-resolution pictures, creating privacy concerns for people who may discover a drone flying nearby.

Today, certain government restrictions exist concerning drones. For example, certain size/weight drones are required to register with a government agency. Also, no-fly zones have been defined where the no-fly zones surround certain areas, such as the White House, military establishments, and government agencies. The no-fly zones for drones are defined based on GPS coordinates that are determined by government agencies and are maintained at a centralized database that is inaccessible to the public. The general public cannot add private no-fly zones or otherwise modify the GPS coordinates of existing no-fly zones. In addition, the general public does not have access to the database of no-fly zones.

### SUMMARY

In accordance with embodiments herein, a method is provided. The method is under control of one or more processors configured with executable instructions. The method broadcasts zonal access rights from a wireless zone access (WZA) apparatus with respect to a local environment. The zonal access rights indicate device permissions granted in connection with the local environment for an electronically-controlled mobile (ECM) device.

Optionally, the broadcasting may comprise broadcasting a wireless network identifier (WNID) for the WZA apparatus in combination with the zonal access rights. The method may define the zonal access rights to include one or more of accessory restrictions and transit restrictions. The zonal access rights may include the accessory restrictions that may limit functionality of an accessory provided on the ECM device. The zonal access rights may include the transit restrictions that may limit one or more a no-fly zone, speed limits, altitude limits, and a no-hover zone. The zonal access rights may include a geographic boundary for a restricted zone of the local environment. The geographic boundary may include one or more of GPS coordinates and a range to the WZA apparatus. The method may further comprise encoding the zonal access rights with the geographic boundary and a wireless network identifier (WNID) for the WZA apparatus. The broadcasting may broadcast the geographic boundary and WNID with the zonal access rights.

In accordance with embodiments herein, an apparatus is provided. The apparatus comprises memory to store zonal access rights associated with a local environment and a transceiver to broadcast the zonal access rights indicating device permissions granted in connection with the local environment for an electronically-controlled mobile (ECM) device.

Optionally, the apparatus may comprise a processor that, when executing executable instructions stored in the memory, may direct the transceiver to broadcast a wireless network identifier (WNID) for the apparatus in combination with the zonal access rights. a user interface may receive, in connection with the zonal access rights, restrictions that limit one or more of camera operation, a no-fly zone, speed limits, altitude limits, and a no-hover zone. A processor may execute instructions stored in the memory to receive information indicating a geographic boundary for a restricted zone of the local environment. The processor may receive one or more of GPS coordinates and a range to the apparatus in connection with the geographic boundary. The processor may encode the geographic boundary with a wireless network identifier (WNID) for the apparatus. The transceiver may broadcast the geographic boundary and WNID with the zonal access restrictions.

In accordance with embodiments herein, a method is provided. The method is under control of one or more processors configured with executable instructions. The method receives a broadcast message at an electronically-controlled mobile (ECM) device, obtains zonal access rights from the broadcast message, determines device permissions for the ECM device granted in connection with a local environment based on the zonal access rights and manages operation of the ECM device relative to the local environment based on the zonal access rights.

Optionally, the receiving may comprise detecting a wireless network identifier (WNID) for a WZA apparatus from the broadcast message and the obtaining may comprise determining the zonal access rights from the broadcast message. The determining may comprise determining that the device permissions define a no fly zone and the managing may comprise limiting navigation of the ECM device to avoid the no fly zone. The determining may comprise determining that the device permissions define an accessory restriction for a restricted zone in connection with the local environment. The managing may comprise limiting functions of the ECM device in connection with operating the ECM device in the restricted zone.

In accordance with embodiments herein, a device is provided. The device comprises memory to store executable instructions. A transceiver is provided to receive remote control instructions and zonal access rights from a broadcast message. A processor is provided that, when executing the executable instructions, to manage navigation of the device based on the remote control instructions, determine device permissions granted in connection with a local environment based on the zonal access rights and manage operation of the device relative to the local environment based on the zonal access rights.

Optionally, the processor, when executing the executable instructions, may detect from the broadcast message a wireless network identifier (WNID) associated with a wireless zone access (WZA) apparatus that transmitted the broadcast message. The processor may determine the zonal access rights appended to the WNID message. The processor, when executing the executable instructions, may determine that the drone permissions define a no fly zone and to limit navigation of the apparatus to avoid the no fly zone. The processor, when executing the executable instructions, may determine that the device permissions define one or more of an accessory restriction and a transit restriction for a restricted zone. The processor may limit functions of the device in connection with the restricted zone based on the one or more of an accessory restriction and a transit restriction.

### BRIEF DESCRIPTION OF THE DRAWINGS

FIG. 1 illustrates a local wireless environment in which a wireless zone access (WZA) apparatus is implemented in accordance with embodiments herein.

FIG. 2 illustrates a flow chart carried out in accordance with embodiments for managing operation of an ECM device based on received zonal access rights in accordance with embodiments herein.

FIG. 3 illustrates a simplified block diagram of an ECM device and remote control unit implemented in accordance with embodiments herein.

FIG. 4 illustrates a simplified block diagram of a WZA apparatus formed in accordance with embodiments herein.

FIG. 5 illustrates a process for programming zonal access restrictions at a WZA apparatus in connection with a local wireless environment in accordance with embodiments herein.

### DETAILED DESCRIPTION

It will be readily understood that the components of the embodiments as generally described and illustrated in the Figures herein, may be arranged and designed in a wide variety of different configurations in addition to the described example embodiments. Thus, the following more detailed description of the example embodiments, as represented in the Figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

It should be clearly understood that the various arrangements and processes broadly described and illustrated with respect to the Figures, and/or one or more individual components or elements of such arrangements and/or one or more process operations associated of such processes, can be employed independently from or together with one or more other components, elements and/or process operations described and illustrated herein. Accordingly, while various arrangements and processes are broadly contemplated, described and illustrated herein, it should be understood that they are provided merely in illustrative and non-restrictive fashion, and furthermore can be regarded as but mere examples of possible working environments in which one or more arrangements or processes may function or operate.

The terms “wireless network identifier” and “WNID” as used throughout, shall refer to an identifier for a wireless network, local, wide or otherwise, or apparatus that provides access to the wireless network. The WNID is typically broadcast within a broadcast message one or more apparatus that provide access to or operate in connection with a network. A non-limiting example of a WNID includes a service set identifier or SSID that is utilized by routers, hubs, and wireless access points in connection with the 802.11 wireless local area network protocol. As another example, the WNID may correspond to identification information transmitted in connection with establishing a cellular, Bluetooth or RF communications session.

The terms “electronically-controlled mobile device” and “ECM device” as used herein, shall refer to any electronic device that is capable of physical navigation over a geographic area while under control of a remote-control unit that communicates with the electronic device wirelessly and/or an autonomous control unit (e.g., an autonomous vehicle). The ECM device may travel through the air, overwater or by ground. Non-limiting examples of ECM devices include airborne drones, remote controlled or autonomous robots, remote controlled or autonomous boats, remote controlled or autonomous automobiles and the like.

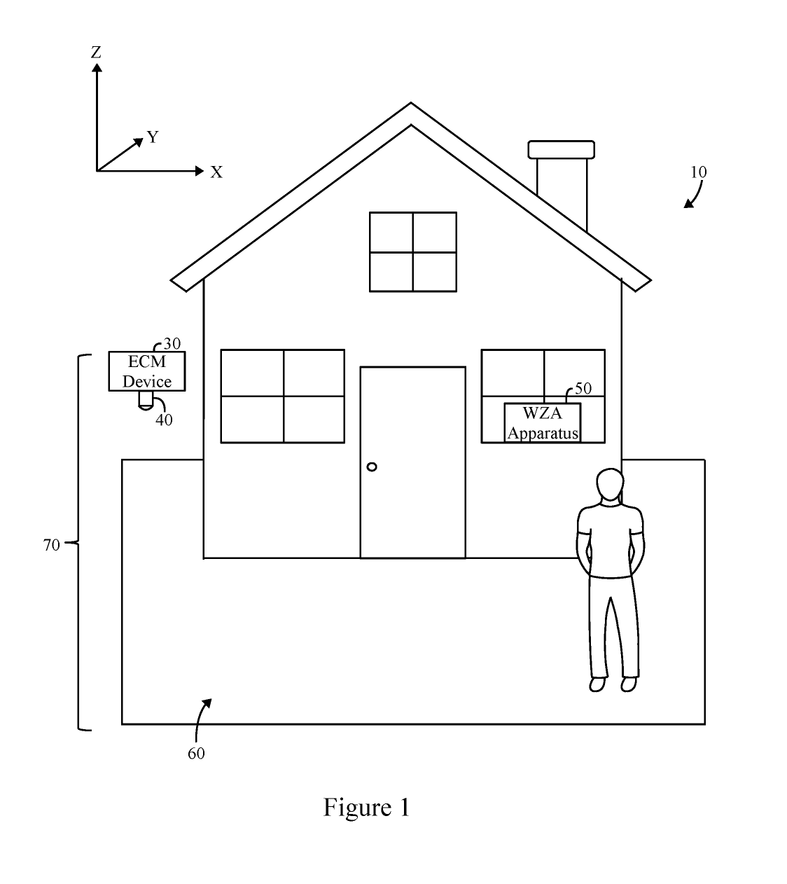

FIG. 1 illustrates a local wireless environment 10 in which a wireless zone access (WZA) apparatus 50 is implemented in accordance with embodiments herein. The local environment 10 may represent a residential, school, religious or commercial premise that includes one or more buildings, a campus, a boat, plane, vehicle and the like. Additionally or alternatively, the local environment may represent an open area of land or water with some or no structures thereon, such as farmland, pastureland, a forest, a subdivision, a golf course, an airfield, ski resort, offshore oil rig and the like. The local wireless environment 10 may also represent a residential or commercial establishment, such as a home, school, campus, religious establishment, warehouse, building, campus, office complex and the like that may be under control of one general entity (e.g., an owner, security company, commercial entity). The range/size of the local wireless environment 10 will vary based on the type of the wireless environment (e.g., local area network, wide area network, cellular, GPS), a range of the WZA apparatus 50, structures within the local wireless environment 10 that may interfere with wireless signals and the like.

An electronically-controlled mobile (ECM) device 30 is shown within the local wireless environment 10. The ECM device 30 may include one or more cameras 40. As explained herein, the WZA apparatus 50 wirelessly broadcast messages that are received by any and all ECM devices 30 within transmit range of the WZA apparatus 50. The broadcast message includes information to restrict activities of the ECM device 30 and/or to define geographic boundaries for a restricted zone 60 surrounding the local wireless environment 10. In accordance with embodiments herein, the WZA apparatus 50 broadcasts zonal access rights with respect to the local wireless environment. The zonal access rights indicate ECM device permissions granted in connection with the local wireless environment 10. For example, the broadcast message may include a wireless network identifier (WNID) for the WZA apparatus 50 in combination with zonal access rights. Non-limiting examples of zonal access rights include accessory and/or transit restrictions for the ECM device 30, such as limits for one or more of camera operation, ECM device altitude (e.g., upper and/or lower thresholds), device speed, no-fly zones, no-loitering zones and the like.

The WZA apparatus 50 may represent a network gateway to a local or wide area network, cellular hotspot, cellular tower, GPS transponder and/or any other electronic device that includes at least a receiver programmed by software and/or firmware to receive and/or support bidirectional communication with one or more predetermined communications protocols. Optionally, the WZA apparatus 50 may include multiple physical devices that are located at separate physical positions (and distributed from one another) within the local wireless environment 10. When multiple physical devices are utilized to collectively form the WZA apparatus 50, the separate physical devices may operate in cooperation with or independent of one another, in a master-slave relation, a client-server relation and the like. Optionally, the multiple physical devices may communicate with a remote/cloud-based server that performs some or all of the operations described herein. Additionally or alternatively, a remote/cloud based server may store information and data utilized in connection with, and/or generated in response to, the operations described herein. Optionally, one or more repeater devices may be utilized with the WZA apparatus 50 to extend a range of the local wireless environment 10.

As an example, the WZA apparatus 50 may represent a router that creates a wireless local area network (WLAN) in accordance with the Institute of Electrical and Electronics Engineers (IEEE) 802.11 protocol. The ECM device 30 connects to the WLAN in accordance to an IEEE 802.11 compatible security algorithm, such as, for example, Wi-Fi Protected Access (WPA), Wi-Fi Protected Access II (WPA2), or Wired Equivalent Privacy (WEP). The WZA apparatus 50 can provide access to network for other WZA apparatus connected to the wireless router directly via bridging functionality integral to the WZA apparatus 50, or in conjunction with bridging functionality, not shown, that is accessible by the WZA apparatus 50. The network can be, for example, a cellular network, a local area network (LAN), a wide area network (WAN) such as the Internet, or a combination of the two, and can include wired, wireless, or fiber optic connections. While the WZA apparatus 50 may provide access to a network, the WZA apparatus 50 performs the broadcasting operations described herein while denying the ECM device 30 access to the LAN, WAN, cellular network and the like. The WZA apparatus 50 performs the broadcasting operations described herein without regard for establishing a communications session with the ECM device 30. Additionally or alternatively, the WZA apparatus 50 may perform the wireless activity detecting and/or tracking operations described herein during a one-way or two-way communication session with the ECM device 30.

For example, the WZA apparatus 50 may be configured to prevent the ECM device 30 from trespassing near an individual's home, from taking pictures of a property without permission and/or otherwise restrict operation of the ECM device 30. The WZA apparatus 50 may represent a wireless router or beacon that broadcasts the zonal access rights over a detection range associated with the WZA apparatus 50. For example, a homeowner may decide not to allow the ECM device 30 to trespass at all and instead require the ECM device 30 to fly around a homeowner's property completely. Using GPS coordinates, the WZA apparatus 50 may be programmed to define a restricted zone 60 surrounding a perimeter of a property. The WZA apparatus 50 may also be programmed with transit restrictions to restrict the ECM device 30 to remain above a predetermined lower altitude 70 or floor when located within the restricted zone 60. Optionally, the WZA apparatus 50 may be programmed to allow the ECM device 30 to travel/transit within the restricted zone 60 within a specified speed range, without stopping/loitering and/or observe other transit restrictions within the restricted zone 60. As another example, the WZA apparatus 50 may be programmed to allow the ECM device 30 to travel over and hover within the restricted zone 60 for up to a maximum predetermined time and/or may be permitted to or prohibited from performing certain remote controlled or autonomous surveillance operations such as taking pictures or videos, hovering within certain altitude ranges and/or observe other transit restrictions for certain periods of time within the restricted zone 60. Alternatively, the zonal access rights may allow the ECM device 30 to take pictures and/or video but may restrict the resolution of the picture or video taken and/or observe other accessory restrictions. For example, the ECM device 30 may be capable of taking 16-megapixel pictures and 1080P video but may receive zonal access rights that restrict image quality to no more than 5 megapixels and restrict videos to 480P, when the ECM device 30 falls below a certain altitude threshold (e.g., 50 feet, 100 feet).

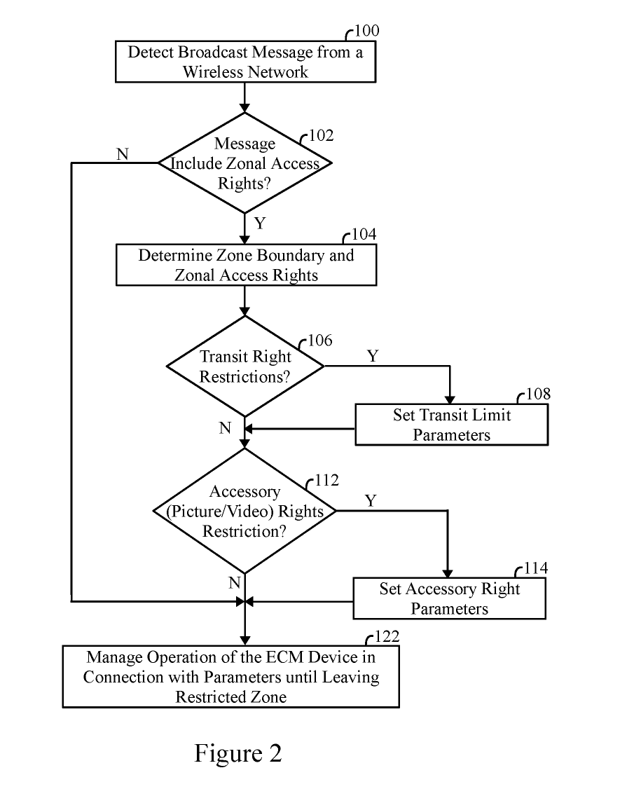

FIG. 2 illustrates a flow chart carried out in accordance with embodiments for managing operation of an ECM device 30 based on received zonal access rights. The operations of FIG. 2 may be carried out by any ECM devices 30 within a broadcast range of the WZA apparatus 50. While the following discussion concerns examples of restrictions in zonal access rights, it is recognized that in some instances, the ECM devices 30 may fly unencumbered with no geographic and/or accessory restrictions regarding flying routes, altitudes, and camera operations. At 100, a transceiver and/or one or more processors of the ECM device 30 receive a broadcast message from the WZA apparatus 50. The broadcast message may be received by an ECM device 30 that is outside of a restricted zone 60, but within transmission range of the WZA apparatus 50.

At 102, one or more processors of the ECM device 30 analyze the broadcast message to determine whether the ECM device 30 is in a restricted fly zone. For example, the one or more processors may unpack the broadcast message to identify content therein. The broadcast message may generally include a WNID. For example, the WZA apparatus 50 may represent a WIFI Access point or the beacon that broadcasts SSIDs (as the WNIDs), whereby the WZA apparatus 50 transmits packets that announce wireless network availability. The SSID is also known as a wireless network name. Various SSIDs may be visible to an ECM device 30 at one point in time such names as “Mike,” “Tom 5G,” and “ATT1234567. In accordance with embodiments herein, the WZA apparatus 50 appends zonal access rights content and/or restricted zone boundaries to the WNID. For example, many communications protocols enable an ID for the wireless network to have a relatively large or unlimited number of characters. Most WNID utilize a somewhat limited number of characters, thus providing a large number of available characters to be appended to an end of the WNID for other purposes (provided the receiving device is programmed to unpack the trailing characters. In accordance with embodiments herein, a predetermined number of characters or portion at a trailing end of the WNID is designated as zonal access rights, while an adjacent trailing portion or characters of the WNID are designated to receive restricted zone boundaries (e.g., GPS coordinates that define a boundary).

At 102, the one or more processors analyze (e.g., unpacks) the broadcast message to identify whether zonal access rights content is included thereon. For example, the processors may unpack and analyze a trailing or predetermined intermediate characters or portion of the WNID for a known indicator designating whether the WNID includes zonal access rights content. When the processors determined that zonal access rights content is present in the WNID, flow moves from 102 to 104. When the processors determined that zonal access rights content are not present in the WNID, the process of FIG. 2 ends and the ECM device 30 operates in an unrestricted manner. For example, when the ECM device 30 represents a drone, if the zone is not a restricted zone for drones, the drone proceeds along an originally planned route as depicted at 122. The ECM device 30 responds fully and completely to, all remote control or autonomous vehicle instructions without regard for any limits.

At 104, the one or more processors of the ECM device 30 unpack or decode the broadcast message to determine a boundary for the restricted zone and the zonal access rights. Thereafter, the operations at 106-108 represent one example of a manner in which the ECM device 30 may be implemented to determine what ECM device 30 permissions are granted in connection with a local environment and to manage operate the ECM device 30 based on the zonal access rights.

At 106, the one or more processors of the ECM device 30 determine whether the zonal access rights include transit right restrictions that limit transit in some manner. Transit restriction generally refers to navigation permissions granted to an ECM device 30 in connection with a geographic region. For example, a no transit zone may be defined wherein an ECM device 30 is not permitted to enter a restricted zone 60. As another option, transit limits may be defined. For example, a transit limit may include whether an ECM device 30 is permitted to hover/loiter, a speed at which an ECM device 30 is permitted to travel (e.g., minimum and/or maximum speeds), a time period for which an ECM device 30 is permitted to remain within a restricted zone, and an altitude at which an ECM device 30 is permitted to travel (e.g., a lower threshold may be set and/or certain ranges may be excluded). When the zonal access rights restrict transit rights in some manner, flow moves to 108.

At 108, the one or more processors manage the transit rights of the ECM device 30 by setting one or more transit limit parameters. Examples of transit limit parameters include “no-fly zone” limit parameters, speed limit parameters, altitude limit parameters, “no hover” limit parameters and the like. As one example, the processors may set a drone navigation state, as a transit limit parameter, to maintain a no hover state or constant moving state. As another example, during navigation, the processors may override a stop instruction received from a remote controlled unit (or autonomous vehicle control unit) and instead direct the ECM device 30 to continuously move through the restricted zone 60. The drone maintains the no hover constant moving state until leaving the restricted zone 60.

Additionally or alternatively, the transit rights may be limited by defining a no-fly zone wherein the ECM device 30 is not permitted to enter or cross certain geographic boundaries. In connection there with, the one or more processors review the boundaries of the restricted zone and set the transit limit parameters to prevent the ECM device 30 from entering the restricted zone 60. For example, the processors may continuously compare a present GPS position or present GPS trajectory of the ECM device to the GPS coordinates of the boundary for the restricted zone 60 and override an instruction from a remote control unit or autonomous vehicle control unit, thereby preventing the ECM device from entering the restricted zone 60 or crossing the boundary.

Additionally or alternatively, the one or more processors may maintain the transit rights of the ECM device 30 by setting a transit limit parameter in connection with an altitude, in which the ECM device 30 is permitted to travel, a transit limit parameter in connection with a period of time in which the ECM device 30 is permitted to remain within the restricted zone and the like. It is recognized that various automated navigation operations may be applied as an ECM device 30 approaches a boundary of a restricted zone 60, such as to adjust a speed to remain within speed limit parameters, and/or to adjust an altitude to remain within altitude limit parameters.

The ECM device may represent an authorized device, such as a delivery or other commercial device that is authorized to enter the restricted zone 60 in connection with certain functions. For example, an ECM device may be a package delivery device. In connection with authorized ECM devices, a broadcast message may include information identifying authorized ECM devices and/or may include navigation related instructions. For example, the broadcast message may include a field identifying a type of authorized ECM devices (e.g., package delivery devices) that are permitted to enter the restricted zone. Additionally or alternatively, the broadcast message may include, as navigation related instructions, GPS coordinates of a location within the restricted zone 60 where packages are to be delivered.

Returning to 106, when the one or more processors determine that that hovering (or any other transit right of interest) is permitted, flow moves to 112. Also, flow moves from 108 to 112. At 112, the one or more processors determine whether the zonal access rights impose accessory restrictions or limits on one or more accessories carried by the ECM device (e.g., still/video cameras). For example, the accessory restriction may be in connection with operation of a video or still image camera. It is recognized that ECM devices (e.g., drones) may have other accessories in addition to, or in place of, cameras (e.g., microphones, speakers, and the like). When an ECM device has other accessories, the operation at 112 may alternatively or additionally determine whether the functionality of such additional accessories is granted, prohibited or otherwise limited by the zonal access rights. At 112, when no accessory restrictions (e.g., pictures/video) are identified at 112, flow moves to 122 and proceeds along a pre-planned route. Alternatively, when accessory restrictions are identified, flow moves to 114.

At 114, the one or more processors manage the accessory restrictions of the ECM device 30 by setting one or more accessory limit parameters. Examples of accessory limit parameters include camera (still or video), microphone, lights or speaker on/off parameters, camera resolution limit parameter, and the like. For example, the processors may turn off a camera, or override an instruction from a remote-control unit, to begin recording video and/or take pictures. When an accessory restriction limits the use of an accessory, the processor sets one or more accessory limit parameters to correspond to the accessory right.

For example, the processors may force the camera 40 of the ECM device 30 to turn off while in the restricted zone 60, meaning no pictures or videos may be taken during ECM device 30 transit of the restricted zone 60. As another example, the processors may limit the resolution of the camera 40 while in the restricted zone 60 at a particular height, yielding low resolution pictures and video. Pictures from the camera could be restricted to 1-megapixel capability and 240P video. Still another example may occur when the processors turn off the microphone of an ECM device 30 that is within the restricted zone 60. An ECM device 30 may be afforded no permission to record any sounds while within the restricted zone 60. Thereafter, flow moves to 122 where the one or more processors of the ECM device 30 manage operation of the ECM device 30 in accordance with the parameters set at 108, 114 until the ECM device 30 travels beyond the range of the restricted zone 60. When the ECM device 30 leaves the restricted zone, the processors reset/cancel the parameters set at 108 and 114 and the ECM device 30 returns to full under control of the remote control unit or autonomous vehicle control unit.

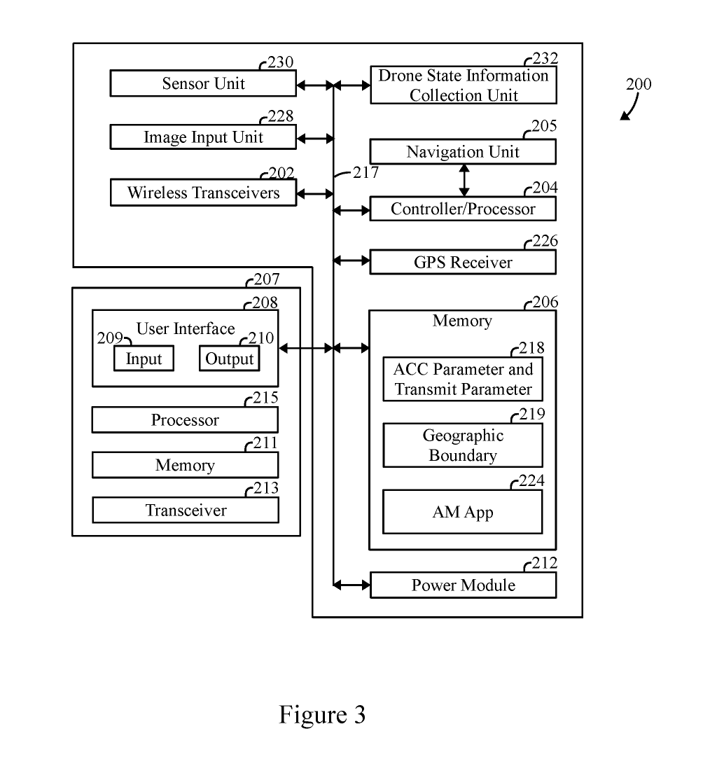

FIG. 3 illustrates a simplified block diagram of an ECM device 200 and remote control unit 207 implemented in accordance with embodiments herein. The remote control unit 207 includes a user interface 208, one or more processors 215, memory 211 and a transceiver 213. The remote control unit 207 may represent a dedicated remote control device, smart phone, tablet computer, laptop computer or any other electronic device known to afford remote control of portable navigation devices. The processors 215 implement executable instructions store in the memory 211 to provide remote control for the ECM device 200. The user interface 208 includes one or more input devices 209 and one or more output devices 210. The input device 209 receives navigation and accessory instructions from a user. The transceiver 213 communicates with the transceiver 202 in connection with providing wireless remote control instructions to the ECM device 200 and to receive audio, video, image and other information from the ECM device 200.

The ECM device 200 includes, among other things, one or more wireless transceivers 202, one or more processors 204 (e.g., a microprocessor, microcomputer, application-specific integrated circuit, etc.), a navigation unit 205, one or more memory (also referred to as a memory portion) 206, a power module 212, and a GPS receiver 226. All of these components can be operatively coupled to one another, and can be in communication with one another, by way of one or more internal communication links 217, such as an internal bus. The navigation unit 205 may represent the electronics, motors and drivers to facilitate navigation, such as motors and propellers in airborne drone, motors, axles, wheels, etc. in a ground drone and the like.

The memory 206 can encompass one or more memory devices of any of a variety of forms (e.g., read only memory, random access memory, static random-access memory, dynamic random-access memory, etc.) and can be used by the processor 204 to store and retrieve data. The data that is stored by the memory 206 can include, but need not be limited to, operating systems, applications, user collected content and informational data. Each operating system includes executable code that controls basic functions of the communication device, such as interaction among the various components and/or communication with external devices via the wireless transceivers 202, and storage and retrieval of applications and data to and from the memory 206. Each application includes executable code that utilizes an operating system to provide more specific functionality for the communication devices, such as file system service and handling of protected and unprotected data stored in the memory 206.

The memory 206 may store, among other things, a zone management application 224 that directs the controller/processor 204 to perform the operations described herein in connection with analyzing broadcast messages, and identifying zone restrictions, transit restrictions and accessory restrictions. When one or more navigation, transit and/or accessory (ACC) limit parameters 218 are set in accordance with the operations of FIG. 2, the settings for the parameters 218 are recorded in the memory 206. When one or more navigation, transit and/or accessory restrictions are set in accordance with the operations of FIG. 2, the geographic boundary 219 for the restricted zone 60 is also recorded in the memory 206.

Each transceiver 202 can utilize a known wireless technology for communication. Exemplary operation of the wireless transceivers 202 in conjunction with other components of the ECM device 200 may take a variety of forms and may include, for example, operation in which, upon reception of wireless signals, the components of ECM device 200 detect communication signals (e.g., broadcast messages) and the transceiver 202 demodulates the communication signals to recover incoming information, such as WNIDs, zone access rights, navigation data, GPS coordinates, map data, and the like transmitted by the wireless signals. The transceiver 202 also receives navigation instructions and accessory operation instructions from the remote control unit 207. After receiving the incoming information from the transceiver 202, the processor 204 formats and stores the incoming information. Likewise, for transmission of wireless signals, the processor 204 formats outgoing information, which may or may not be activated by the input devices 209 and conveys the outgoing information to one or more of the wireless transceivers 202 for modulation to communication signals.

In accordance with embodiments herein, GPS receiver 226 receives GPS information from GPS satellites. The GPS receiver 226 uses the GPS information to calculate navigation data, as well as a current location and a speed of the drone while flying. The ECM device 200 may also include an image input unit (e.g., camera) 228, a sensor unit 230, and an ECM device state information collection unit 232. The image input unit 228 generates image data corresponding to external still or video inputs indicative of an environment and features surrounding the ECM device. For example, the image input unit 228 may represent one or more cameras positioned on the ECM device and oriented with fields of view directed toward the front of the ECM device, the rear of the ECM device and/or the sides of the ECM device.

The sensor unit 230 senses the speed, shock, vibration, and direction of the drone. For example, the sensor unit 230 includes, but not limited to, an inertial sensor such as an accelerometer, a gyroscope, a shock sensor, a tilt sensor, etc., an altimeter, a gravity sensor, obstacle sensor, and a geomagnetic sensor, alone or in combination. The sensor unit 230 may also be configured with any other type of sensor that can sense movement of the ECM device 30. The processor 204 receives a sensed value or sensed data from the sensor unit 230 and compares the sensed value or sensed data in order to derive non-GPS navigation information, direction change information, and the like.

According to an embodiment, a WNID from a WZA apparatus within a restricted zone 60 may deactivate application 224 and cease drone image capture operations. However, when application 224 is activated, the processor 204 controls the image input unit 228 to begin image capture. The image input unit 228 may capture image data continuously, periodically or in response to select events. The processor 204 may determine select events based on sensed values (e.g., change of direction) received from the sensor unit 230. The image data may include still images, video, etc., captured before and after select events.

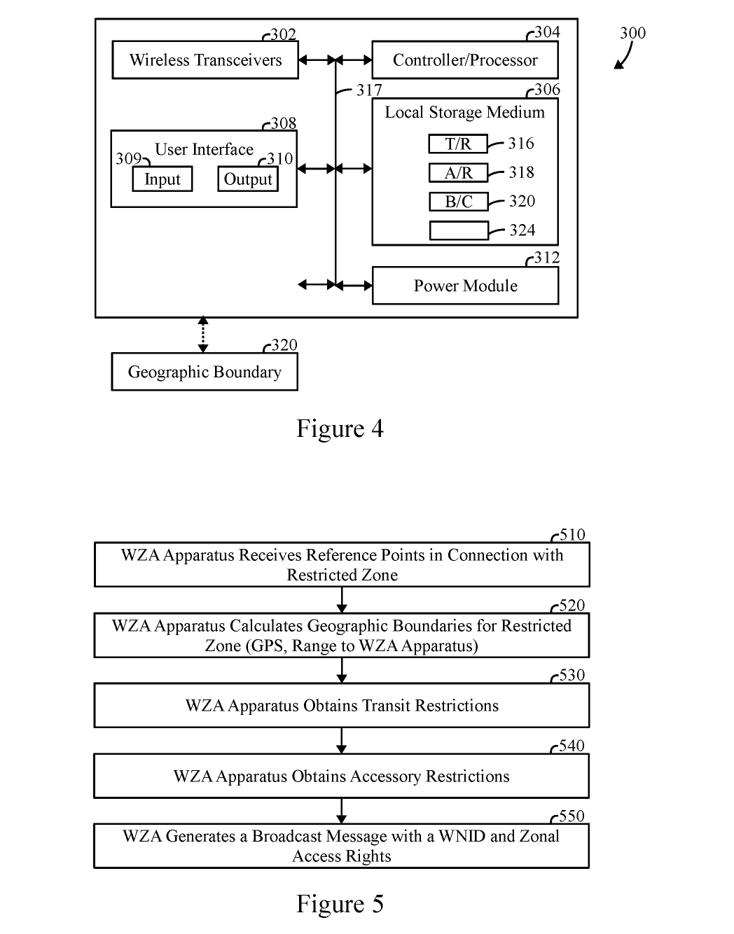

FIG. 4 illustrates a simplified block diagram of a WZA apparatus 300 formed in accordance with an embodiment herein. The WZA apparatus 300 includes components such as one or more wireless transceivers 302, one or more processors 304 (e.g., a microprocessor, microcomputer, application-specific integrated circuit, etc.), one or more memory (also referred to as a memory portion) 306, a user interface 308 which includes one or more input devices 309 and one or more output devices 310, and a power module 312. All of these components can be operatively coupled to one another, and can be in communication with one another, by way of one or more internal communication links 317, such as an internal bus. The one or more transceivers 302 broadcast messages that include zonal access rights indicating ECM device permissions granted in connection with the local wireless environment 10. The one or more transceivers 302 may broadcast a WNID with the zonal access rights appended thereto, where the zonal access rights may include restrictions on camera operations, ECM device altitude, and transit operations. Optionally, the WNID and zonal access rights may be broadcast separate from one another. Optionally, the WNID may be omitted entirely and the zonal access rights broadcast alone as a stand-alone broadcast message.

The input and output devices 309, 310 may each include a variety of visual, audio, and/or mechanical devices. For example, input devices 309 can include remote computing connections via Ethernet or wireless, keyboard, keypad, selection hard and/or soft buttons, switch, touchpad, touch screen, icons on a touch screen, a touch sensitive area on a touch sensitive screen and/or any combination thereof. Similarly, the output devices 310 can include a visual output device such as one or more light emitting diode indicators, a liquid crystal display screen, an audio output device such as a speaker, and alarm and/or buzzer.

The memory 306 can encompass one or more memory devices of any of a variety of forms (e.g., read only memory, random access memory, static random-access memory, dynamic random-access memory, etc.) and can be used by the processor 304 to store and retrieve data. The data that is stored by the memory 306 can include, but need not be limited to operating systems, applications, user collected content, and informational data. Each operating system includes executable code that controls basic functions of the communication device, such as interaction among the various components and/or communication with external devices via the wireless transceivers 302, and storage and retrieval of applications and data to and from the memory 306. Each application includes executable code that utilizes an operating system to provide more specific functionality for the communication devices, such as file system service and handling of protected and unprotected data stored in the memory 306.

As explained herein, the memory 306 stores content associated with the local environment such as transit restrictions 316 (e.g., prohibition on entering zone, no hover, altitude restrictions) and/or accessory restriction 318 (e.g., camera operations restrictions). In addition, the memory 306 may store a zone boundary 320, such as defined by GPS zone coordinates and the like.

Additionally or alternatively, a database of allowed ECM devices IDs may be stored in the memory 306 to differentiate between ECM devices allowed and not allowed to transit and operate within the restricted zone. For example, an owner of a drone may not want most drones flying over his or her property but may provide full access and rights within their restricted zone 60 to drones owned by friends, family, or themselves. Also, ECM device IDs may be stored for non-compliant ECM devices flying within the restricted zone and timing information associated with such ECM devices, such as associated routes, such as time of day, and days of the week. The transit restrictions 316, accessory restrictions 318 and geographic boundary 320 may be generated and updated continuously throughout operation of the method, such as through a background application and also be generated by a user entering information manually.

In addition, zonal access rights include a geographic boundary 320 for a restricted zone 60 of the local wireless environment 10. Geographic boundary coordinates 320 are utilized to identify the geographic boundary of the restricted zone, and the broadcasted WLS includes WNIDs along with the geographic boundaries to alert airborne drone of the zonal access rights in the restricted zone 60. Additionally or alternatively, a captive portal communications session may also be conducted to transmit zonal access rights to an ECM device 30.

Other applications stored in the memory 306 include various application program interfaces (APIs). The power module 312 preferably includes a power supply, such as a battery, for providing power to the other components.

Each transceiver 302 can utilize a known wireless technology for communication. Exemplary operation of the wireless transceivers 302 in conjunction with other components of the WZA apparatus 300 may take a variety of forms and may include, for example, operation in which, upon the WNID broadcast, the components of WZA apparatus 300 detect ECM device communication signals and the ECM device transceiver 202 demodulates the communication signals to recover incoming information, such as zone access rights, navigation data, GPS coordinates, map data, and the like transmitted by the WNID broadcast. While transmitting the WNID broadcast, the processor 304 formats outgoing information, which may or may not be activated by the input devices 309 and conveys the outgoing information to one or more of the wireless transceivers 302 for modulation to communication signals.

FIG. 5 illustrates a process for programming zonal access restrictions at a WZA apparatus 50 in connection with a local wireless environment. At 510, one or more processors of the WZA apparatus 50 receive boundary points that define a perimeter of a restricted zone 60. For example, a user may walk around a perimeter of the local wireless environment 10 using a cellphone or other mobile device as an input device along with an application that conveys to the WZA apparatus 50 geographic boundary points. Using an app associated with the WZA apparatus 50, the user may press a button on the cellphone screen to establish the geographic boundary points of the restricted zone 60. Further, geographic boundaries may be determined with angular ranges. For example, the homeowner may utilize an app connected to the router to enter angles in a polar coordinate system to establish a geographic boundary for the local environment.

At 520, the one or more processors calculate the geographic boundary of the local wireless environment 10 based on the geographic boundary points created by the user. Optionally, the geographic boundary points may be downloaded from a mapping program, based on the GPS coordinates of the user's property. The altitude limit of the ECM device 30 may be manually entered via the cellphone app or a web-based user interface for the WZA apparatus or may be automatically established via a default setting in the WZA apparatus.

At 530, the one or more processors receive navigation or transit limit restrictions. For example, airborne drone altitude restrictions may be entered manually from the input 309. As another example, drone altitudes may be entered for desired distances away from a home or other property. For example, transit restrictions may be set at zero for no restriction, 50 feet, 100 feet, or infinity for no access. Additionally or alternatively, the homeowner can set geographic boundaries by entering a range on different sides of the homeowner's property.

At 540, the one or more processors receive accessory restrictions setting one or more accessory limit parameters, including, but not limited to camera (still or video) on/off parameters, microphone, lights or speaker on/off parameters, camera resolution limit parameter, and the like. The accessory restrictions are stored in memory 306.

At 550, the one or more processors generate a broadcast message with a wireless network identifier and zonal access rights. In accordance with embodiments herein, the WZA apparatus 50 appends zonal access rights content and/or restricted zone boundary content to an end of the WNID. For example, a protocol may be defined in which a predetermined number of characters or portion at the trailing end of the WNID may be designated as a ZAR field to receive zonal access rights (ZAR), while an adjacent trailing portion or characters of the WNID may be designated as a RZB field to receive restricted zone boundaries (RZB) (e.g., GPS coordinates that define a boundary). The processors may populate ZAR field with predetermined codes that correspond to the accessory and/or transit restrictions, such as through a look up table. The processors may populate RZB field with GPS coordinate and/or a range to a WZA apparatus. Thereafter, the WZA apparatus 50 continuously or iteratively broadcasts the broadcast message with the WNID, zonal access rights and boundary for the restricted zone.

The ECM device may represent an authorized device, such as a delivery or other commercial device that is authorized to enter the restricted zone 60 in connection with certain functions. For example, an ECM device may be a package delivery device. In connection with authorized ECM devices, the one or more processors may add to the broadcast message information identifying authorized ECM devices and/or may include navigation related instructions. For example, the processors may add a specific identifier for a particular authorized ECM device to the broadcast message. Additionally or alternatively, the processors may add to the broadcast message a field identifying a type of authorized ECM devices (e.g., package delivery devices) that are permitted to enter the restricted zone. Additionally or alternatively, the processors may add to the broadcast message GPS coordinates of a location within the restricted zone 60 where packages are to be delivered. Additionally or alternatively, the processors may add other navigation related instructions to the broadcast message.

As will be appreciated by one skilled in the art, various aspects may be embodied as a system, method or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable storage medium(s) having computer (device) readable program code embodied thereon.

Any combination of one or more non-signal computer (device) readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface, and a storage device for storing code may store the program code for carrying out the operations and provide this code through its network interface via a network to a second device having a second processor for execution of the code on the second device.

Aspects are described herein with reference to the Figures, which illustrate example methods, devices and program products according to various example embodiments. These program instructions may be provided to a processor of a general purpose computer, special purpose computer, or other programmable data processing device or information handling device to produce a machine, such that the instructions, which execute via a processor of the device implement the functions/acts specified. The program instructions may also be stored in a device readable medium that can direct a device to function in a particular manner, such that the instructions stored in the device readable medium produce an article of manufacture including instructions which implement the function/act specified. The program instructions may also be loaded onto a device to cause a series of operational steps to be performed on the device to produce a device implemented process such that the instructions which execute on the device provide processes for implementing the functions/acts specified.

The units/modules/applications herein may include any processor-based or microprocessor-based system including systems using microcontrollers, reduced instruction set computers (RISC), application specific integrated circuits (ASICs), field-programmable gate arrays (FPGAs), logic circuits, and any other circuit or processor capable of executing the functions described herein. Additionally or alternatively, the modules/controllers herein may represent circuit modules that may be implemented as hardware with associated instructions (for example, software stored on a tangible and non-transitory computer readable storage medium, such as a computer hard drive, ROM, RAM, or the like) that perform the operations described herein. The above examples are exemplary only, and are thus not intended to limit in any way the definition and/or meaning of the term “controller.” The units/modules/applications herein may execute a set of instructions that are stored in one or more storage elements, in order to process data. The storage elements may also store data or other information as desired or needed. The storage element may be in the form of an information source or a physical memory element within the modules/controllers herein. The set of instructions may include various commands that instruct the modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, in the following claims, the phrases “at least A or B”, “A and/or B”, and “one or more of A and B” (where “A” and “B” represent claim elements), are used to encompass i) A, ii) B and/or iii) both A and B. For the avoidance of doubt, the claim limitation “to include drone accessory restrictions that limit one or more of camera operation, drone altitude and transit operations” means and shall encompass i) “drone accessory restrictions that limit camera operation,” ii) “drone accessory restrictions that limit drone altitude.” iii) “drone accessory restrictions that limit transmit operations” and/or iv) “drone accessory restrictions that limit camera operation, drone altitude and transit operations”.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

What is claimed is:

1. A method, comprising:
under control of one or more processors configured with executable instructions;
broadcasting zonal access rights from a wireless zone access (WZA) apparatus with respect to a local environment, the zonal access rights indicating device permissions granted in connection with the local environment for an electronically-controlled mobile (ECM) device.

2. The method of claim 1, wherein the broadcasting comprises broadcasting a wireless network identifier (WNID) for the WZA apparatus in combination with the zonal access rights.

3. The method of claim 1, further comprising defining the zonal access rights to include one or more of accessory restrictions and transit restrictions.

4. The method of claim 3, wherein the zonal access rights include the accessory restrictions that limit functionality of an accessory provided on the ECM device.

5. The method of claim 3, wherein the zonal access rights include the transit restrictions that limit one or more of a no-fly zone, speed limits, altitude limits, and a no-hover zone.

6. The method of claim 1, further comprising defining the zonal access rights to include a geographic boundary for a restricted zone of the local environment, wherein the geographic boundary includes one or more of GPS coordinates and a range to the WZA apparatus, the method further comprising encoding the zonal access rights with the geographic boundary and a wireless network identifier (WNID) for the WZA apparatus, the broadcasting comprising broadcasting the geographic boundary and WNID with the zonal access rights.

7. An apparatus, comprising:
memory to store zonal access rights associated with a local environment;
a processor to execute instructions stored in the memory; and
a transceiver to broadcast the zonal access rights indicating device permissions granted in connection with the local environment for an electronically-controlled mobile (ECM) device.

8. The apparatus of claim 7, wherein the processor, in response to executing the executable instructions stored in the memory, directs the transceiver to broadcast a wireless network identifier (WNID) for the apparatus in combination with the zonal access rights.

9. The apparatus of claim 7, further comprising a user interface to receive, in connection with the zonal access rights, restrictions that limit one or more of camera operation, a no-fly zone, speed limits, altitude limits, and a no-hover zone.

10. The apparatus of claim 7, wherein the processor, in response to executing the instructions stored in the memory, to receive information indicating a geographic boundary for a restricted zone of the local environment.

11. The apparatus of claim 10 wherein the processor to receive one or more of GPS coordinates and a range to the apparatus in connection with the geographic boundary, the processor to encode the geographic boundary with a wireless network identifier (WNID) for the apparatus, the transceiver to broadcast the geographic boundary and WNID with the zonal access restrictions.

12. A method, comprising:
under control of one or more processors configured with executable instructions;
receiving a broadcast message at an electronically-controlled mobile (ECM) device;
obtaining zonal access rights from the broadcast message;
determining device permissions for the ECM device granted in connection with a local environment based on the zonal access rights;
managing operation of the ECM device relative to the local environment based on the zonal access rights.

13. The method of claim 12, wherein the receiving comprises detecting a wireless network identifier (WNID) for a wireless zone access (WZA) apparatus from the broadcast message and the obtaining comprises determining the zonal access rights from the broadcast message.

14. The method of claim 12, wherein the determining comprises determining that the device permissions define a no fly zone and the managing comprises limiting navigation of the ECM device to avoid the no fly zone.

15. The method of claim 12, wherein the determining comprises determining that the device permissions define an accessory restriction for a restricted zone in connection with the local environment; and wherein the managing comprises limiting functions of the ECM device in connection with operating the ECM device in the restricted zone.

16. A device, comprising:
memory to store executable instructions;
a transceiver to receive zonal access rights from a broadcast message; and
a processor that, in response to executing the executable instructions, to:
manage navigation of the device based on the control instructions;
determine device permissions granted in connection with a local environment based on the zonal access rights; and
manage operation of the device relative to the local environment based on the zonal access rights.

17. The device of claim 16, wherein the processor, in response to executing the executable instructions, to detect from the broadcast message a wireless network identifier (WNID) associated with a wireless zone access (WZA) apparatus that transmitted the broadcast message, the processor to determine the zonal access rights appended to the WNID message.

18. The apparatus of claim 16, wherein the processor, in response to executing the executable instructions, to determine that the drone permissions define a no fly zone and to limit navigation of the apparatus to avoid the no fly zone.

19. The apparatus of claim 16, wherein the processor, in response to executing the executable instructions, to determine that the device permissions define one or more of an accessory restriction and a transit restriction for a restricted zone; and to limit functions of the device in connection with the restricted zone based on the one or more of an accessory restriction and a transit restriction.

20. The apparatus of claim 16, wherein the transceiver to receive remote control instructions.
